(19) United States
(12) Patent Application Publication
(10) Pub. No.: US 2013/0223239 A1
(43) Pub. Date: Aug. 29, 2013

(54) IRAT MEASUREMENT METHOD WHEN IN TD-SCDMA CONNECTED MODE

(71) Applicants: Ming Yang, San Diego, CA (US); Tom Chin, San Diego, CA (US); Mungal Singh Dhanda, Slough (GB); Guangming Shi, San Diego, CA (US)

(72) Inventors: Ming Yang, San Diego, CA (US); Tom Chin, San Diego, CA (US); Mungal Singh Dhanda, Slough (GB); Guangming Shi, San Diego, CA (US)

(73) Assignee: QUALCOMM Incorporated, San Diego, CA (US)

(21) Appl. No.: 13/407,652

(22) Filed: Feb. 28, 2012

(51) Int. Cl. H04W 24/10

(52) U.S. Cl. 370/252

(57) ABSTRACT

When a user equipment (UE) is operating in connected mode in a Time Division-Synchronous Code Division Multiple Access (TD-SCDMA) network all time slots may be allocated to communications, leaving insufficient time for the UE to perform measurement of neighboring radio access technologies (RATs). When the UE moves out of TD-SCDMA coverage, it may report to the base station and receive an instruction to switch into time division multiplexing (TDM) mode and to perform inter-RAT measurement while in TDM mode.

### BACKGROUND

1. Field

Aspects of the present disclosure relate generally to wireless communication systems, and more particularly, to improving measurement between radio access technologies when a user equipment is in TD-SCDMA connected mode.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4A is a block diagram showing communication subframes in non-TDM mode.

FIG. 4B is a block diagram showing communication subframes in TDM mode.

FIG. 5 is a functional block diagram illustrating improved inter-RAT measurement according to one aspect of the present disclosure.

FIG. 6 is a block diagram illustrating components for improved inter-RAT measurement according to one aspect of the present disclosure.

### SUMMARY

Offered is a method for wireless communication. The method includes reporting to a base station when a user equipment (UE) moves out of a network coverage area. The method also includes receiving an instruction to switch from non-time division multiplexing mode into time division multiplexing (TDM) mode. The method further includes performing inter-radio access technology (IRAT) measurement in a TDM off duration once the UE is in TDM mode.

Offered is an apparatus for wireless communication. The apparatus includes means for reporting to a base station when a user equipment (UE) moves out of a network coverage area. The apparatus also includes means for receiving an instruction to switch from non-time division multiplexing mode into time division multiplexing (TDM) mode. The apparatus further includes means for performing inter-radio access technology (IRAT) measurement in a TDM off duration once the UE is in TDM mode.

Offered is a computer program product for wireless communications. The computer program product includes a non-transitory computer-readable medium having program code recorded thereon. The program code includes program code to report to a base station when a user equipment (UE) moves out of a network coverage area. The program code also includes program code to receive an instruction to switch from non-time division multiplexing mode into time division multiplexing (TDM) mode. The program code further includes program code to perform inter-radio access technology (IRAT) measurement in a TDM off duration once the UE is in TDM mode.

Offered is an apparatus wireless communications. The apparatus includes a memory and a processor(s) coupled to the memory. The processor(s) is configured to report to a base station when a user equipment (UE) moves out of a network coverage area. The processor(s) is also configured to receive an instruction to switch from non-time division multiplexing mode into time division multiplexing (TDM) mode. The processor(s) is further configured to perform inter-radio access technology (IRAT) measurement in a TDM off duration once the UE is in TDM mode.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

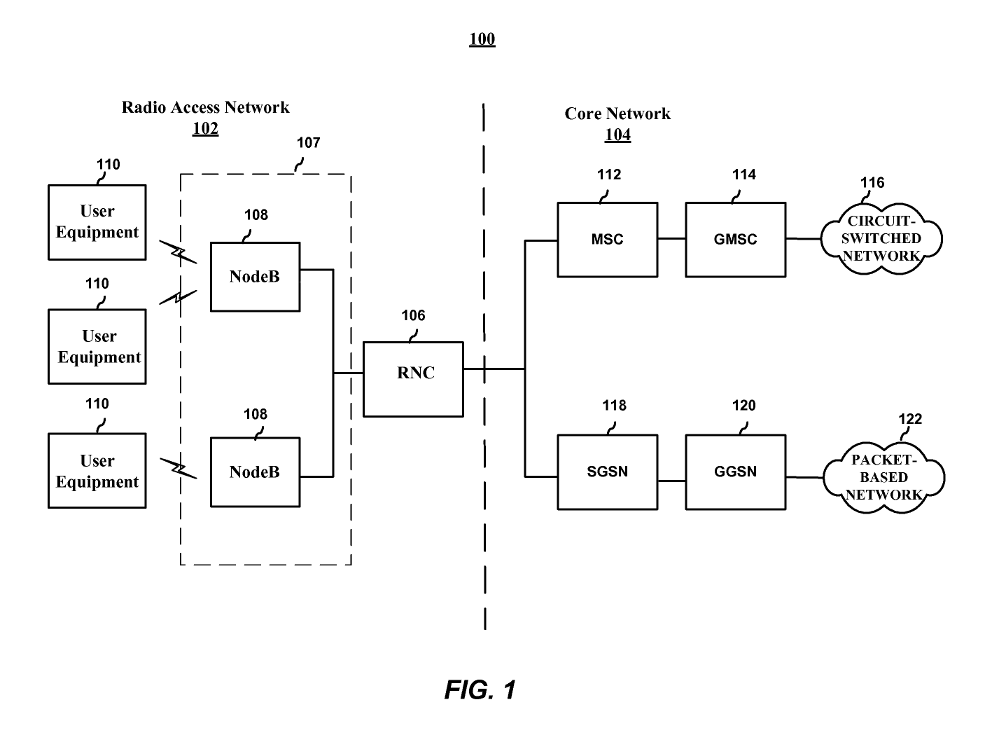

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

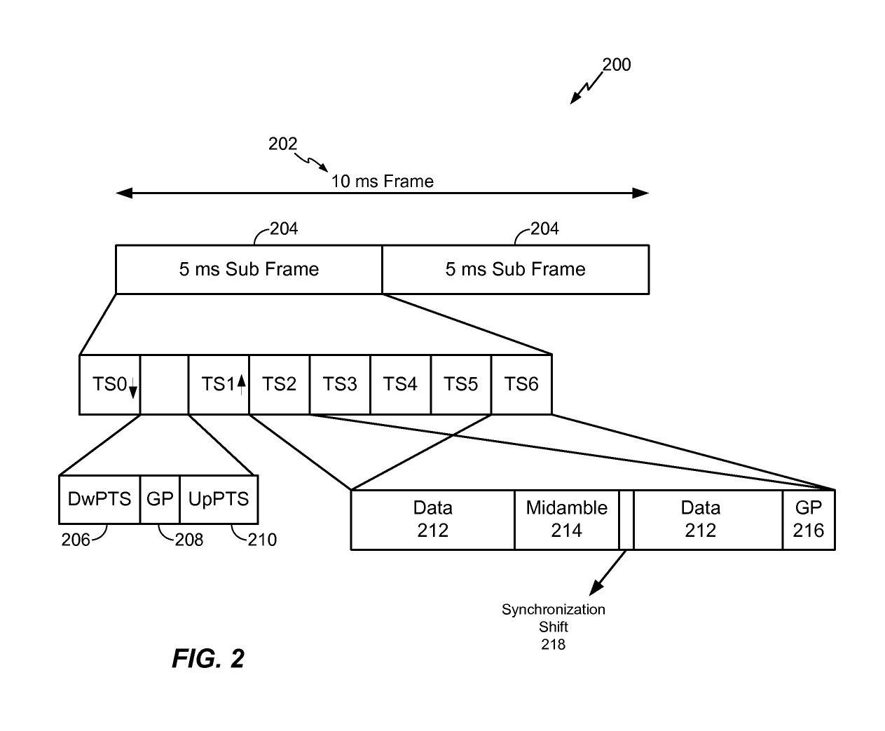

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

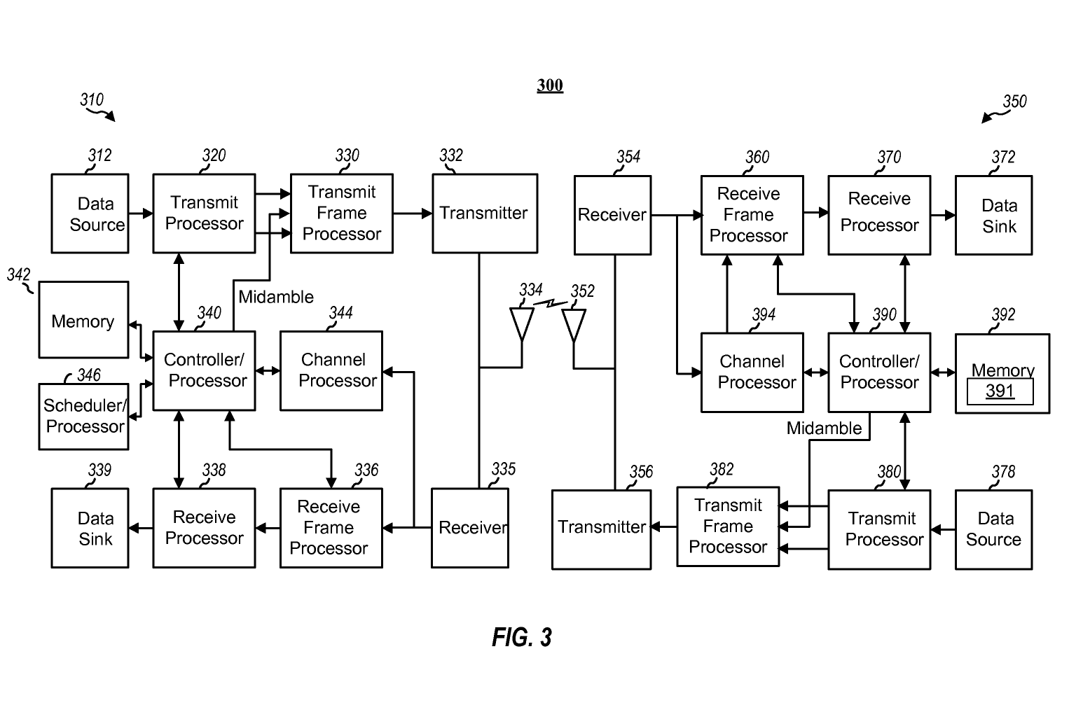

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a inter-RAT measurement module 391 which, when executed by the controller/processor 390, configures the UE 350 as indicated below. A scheduler/processor 346 at the node B 310 may be used to allocate resources to the UEs and schedule downlink and/or uplink transmissions for the UEs.

A radio bearer may use one or more channel codes for each timeslot to send data. For example, a circuit-switched (CS) 12.2 kbps radio bearer may use two channel codes in one uplink timeslot and two channel codes in one downlink timeslot to transmit. All other time slots are idle time slots which, when the UE is not in connected mode, the UE may use to alter its tuned frequency to perform measurement of neighboring radio access technologies (RATs) (inter-RAT, or IRAT, measurement).

In TD-SCDMA, there is no compress mode, thus only idle slots may be used to perform IRAT measurement (such as a measuring a Global System for Mobile Communications (GSM) network). Due to the short duration of non-consecutive idle slots, IRAT measurement is challenging, especially for multi timeslot packet-switched (PS) calls and multi-RAT calls. In certain cases no idle time slot is available, thus increasing the time to complete IRAT measurements, sometimes even resulting in a failure to perform IRAT measurements.

Proposed is an approach for improving a UE's ability to perform IRAT measurements. When a UE moves out of TD-SCDMA coverage or moves into coverage holes, the UE may report the move to the network. The network may then reconfigure the UE from non-TDM (time division multiplex) operation to TDM operation. In non-TDM mode all subframes are used for transmit/receive communications. In TDM mode the network may configure a group of subframes for UE communications (called an ON period) and other subframes when the UE is not communicating (called an OFF period).

Based on a ratio between repetition length (i.e., between ON durations) and the repetition period, the network may assign more channel codes or more time slots in the ON duration. The OFF duration (and idle time slots in ON duration) may then be used by the UE for IRAT measurements. For example, for circuit switched 12.2 kbps radio bearer operation, a transit time interval (TTI) is 20 ms long (i.e., 4 subframes*5 ms per subframe) for non-TDM mode, where there are transmit/receive operations on every subframe. For each subframe, two channel codes and one time slot are used for both downlink and uplink.

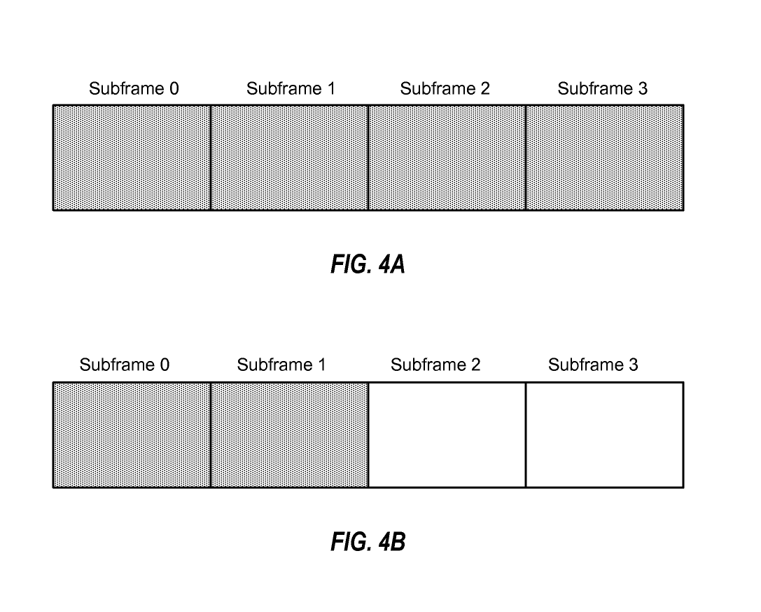

For example, as shown in FIG. 4A, non-TDM mode operation may result in all subframes being used for communication (indicated by the shading). In TDM mode, as shown in FIG. 4B, certain subframes (subframes 2 and 3) may be quieted and not used for communication. Those subframes may then be used for IRAT measurement. For TDM mode, as shown in the example of FIG. 4B, the ON-duration may be configured with the first two subframes, and the OFF-duration in the last two subframes. For the first two subframes, four codes and one time slot are used for both downlink and uplink, or two codes and two time slots are used for both downlink and uplink based on code/time slot resource availability. Thus, the OFF-duration (i.e., the last two subframes) in addition to idle time slots in the first two subframes may be used for IRAT measurement. Because the OFF-duration is consecutive and longer than in non-TDM mode, IRAT measurements may be performed more effectively thus allowing the UE to complete IRAT measurements (and potentially handover) faster rather than remaining in weak coverage for an extended time. Thus, the proposed method may reduce potential call drop before IRAT handover occurs.

If the coverage sufficiently improves, i.e., received signal strength is above a pre-defined threshold, the network may reconfigure the UE from TDM mode back to non-TDM mode in response to receiving the report from the UE.

This proposed method may result in specification changes to improve co-operation between the UE and network to control TDM/non-TDM modes. When the UE is in TDM mode, uplink synchronization and power control may follow previously specified procedures. The proposed methods allow the UE to effectively perform IRAT measurement in TD-SCDMA systems without losing throughput or disrupting services.

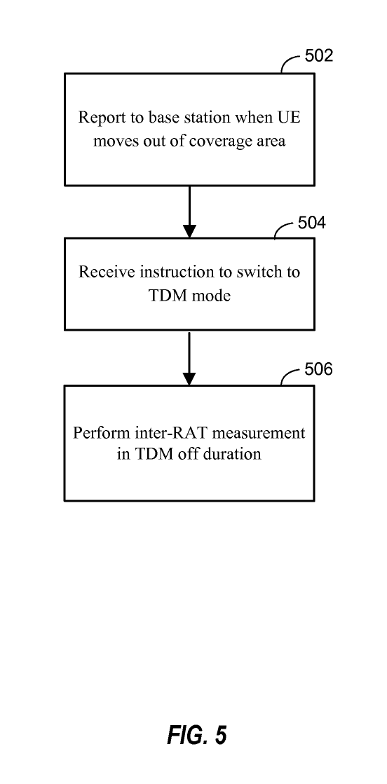

As shown in FIG. 5 a UE may report to a base station when a user equipment (UE) moves out of a network coverage area, as shown in block 502. A UE may receive an instruction to switch from non-time division multiplexing mode into time division multiplexing (TDM) mode, as shown in block 504. A UE may perform inter-radio access technology (IRAT) measurement in a TDM off duration once the UE is in TDM mode, as shown in block 506.

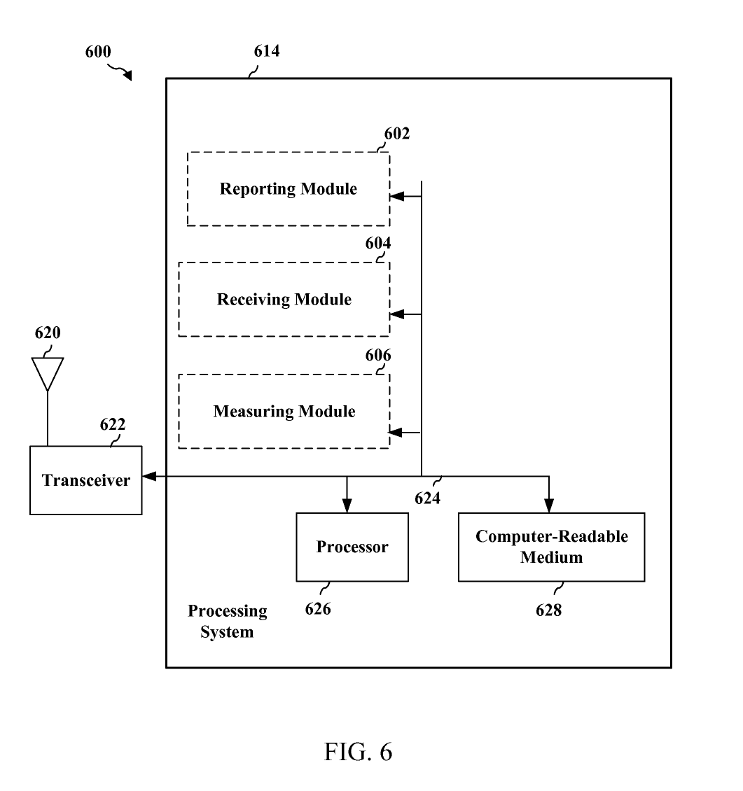

FIG. 6 is a diagram illustrating an example of a hardware implementation for an apparatus 600 employing a inter-RAT measurement system 614. The inter-RAT measurement system 614 may be implemented with a bus architecture, represented generally by a bus 624. The bus 624 may include any number of interconnecting buses and bridges depending on the specific application of the inter-RAT measurement system 614 and the overall design constraints. The bus 624 links together various circuits including one or more processors and/or hardware modules, represented by a processor 626, a reporting module 602, a receiving module 604 and a measuring module 606, and a computer-readable medium 628. The bus 624 may also link various other circuits such as timing sources, peripherals, voltage regulators, and power management circuits, which are well known in the art, and therefore, will not be described any further.

The apparatus includes the inter-RAT measurement system 614 coupled to a transceiver 622. The transceiver 622 is coupled to one or more antennas 620. The transceiver 622 provides a means for communicating with various other apparatus over a transmission medium. The inter-RAT measurement system 614 includes the processor 626 coupled to the computer-readable medium 628. The processor 626 is responsible for general processing, including the execution of software stored on the computer-readable medium 628. The software, when executed by the processor 626, causes the inter-RAT measurement system 614 to perform the various functions described supra for any particular apparatus. The computer-readable medium 628 may also be used for storing data that is manipulated by the processor 626 when executing software. The inter-RAT measurement system 614 further includes the reporting module 602 for reporting to a base station when a user equipment (UE) moves out of a network coverage area. The inter-RAT measurement system 614 further includes the receiving module 604 for receiving an instruction to switch from non-time division multiplexing mode into time division multiplexing (TDM) mode. The inter-RAT measurement system 614 further includes the measuring module 606 for performing inter-radio access technology (IRAT) measurement in a TDM off duration once the UE is in TDM mode. The reporting module 602, the receiving module 604 and the measuring module 606 may be software modules running in the processor 626, resident/stored in the computer readable medium 628, one or more hardware modules coupled to the processor 626, or some combination thereof. The inter-RAT measurement system 614 may be a component of the UE 350 and may include the memory 392 and/or the controller/processor 390.

In one configuration, the apparatus 500 for wireless communication includes means for reporting. The means may be the reporting module 604, the controller/processor 390, the memory 392, the inter-RAT measurement module 391, the transmit processor 380, the channel processor 394, the transceiver 622, the antenna 620/352, the transmitter 356, and/or the inter-RAT measurement system 614 of the apparatus 600 configured to perform the functions recited by the measuring and recording means. In another aspect, the aforementioned means may be any module or any apparatus configured to perform the functions recited by the aforementioned means.

In one configuration, the apparatus 600 for wireless communication includes means for receiving. The means may be the receiving module 604, the controller/processor 390, the memory 392, the inter-RAT measurement module 391, the receive processor 370, the channel processor 394, the transceiver 622, the antenna 620/352, the receiver 354, and/or the inter-RAT measurement system 614 of the apparatus 600 configured to perform the functions recited by the measuring and recording means. In another aspect, the aforementioned means may be any module or any apparatus configured to perform the functions recited by the aforementioned means.

In one configuration, the apparatus 500 for wireless communication includes means for measuring. The means may be the measuring module 606, the controller/processor 390, the memory 392, the inter-RAT measurement module 391, the receive processor 370, the transmit processor 380, the channel processor 394, the transceiver 622, the antenna 620/352, the receiver 354, and/or the inter-RAT measurement system 614 of the apparatus 600 configured to perform the functions recited by the measuring and recording means. In another aspect, the aforementioned means may be any module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
reporting to a base station when a user equipment (UE) moves out of a network coverage area;
receiving an instruction to switch from non-time division multiplexing mode into time division multiplexing (TDM) mode; and
performing inter-radio access technology (IRAT) measurement in a TDM off duration once the UE is in TDM mode.

2. The method of claim 1, further comprising communicating during a TDM on duration with increased resources to compensate for data that would have been transmitted in the TDM off duration if TDM mode was not configured.

3. The method of claim 2 in which the resources comprise at least one of time slots and channel codes.

4. The method of claim 1 in which the TDM off duration comprises consecutive subframes.

5. The method of claim 1 in which the network is a Time Division-Synchronous Code Division Multiple Access (TD-SCDMA) network.

6. An apparatus for wireless communication, comprising:
means for reporting to a base station when a user equipment (UE) moves out of a network coverage area;
means for receiving an instruction to switch from non-time division multiplexing mode into time division multiplexing (TDM) mode; and
means for performing inter-radio access technology (IRAT) measurement in a TDM off duration once the UE is in TDM mode.

7. The apparatus of claim 6, further comprising means for communicating during a TDM on duration with increased resources to compensate for data that would have been transmitted in the TDM off duration if TDM mode was not configured.

8. The apparatus of claim 7 in which the resources comprise at least one of time slots and channel codes.

9. The apparatus of claim 6 in which the TDM off duration comprises consecutive subframes.

10. The apparatus of claim 6 in which the network is a Time Division-Synchronous Code Division Multiple Access (TD-SCDMA) network.

11. A computer program product for wireless communications, the computer program product comprising:
a non-transitory computer-readable medium having program code recorded thereon, the program code comprising:
program code to report to a base station when a user equipment (UE) moves out of a network coverage area;
program code to receive an instruction to switch from non-time division multiplexing mode into time division multiplexing (TDM) mode; and
program code to perform inter-radio access technology (IRAT) measurement in a TDM off duration once the UE is in TDM mode.

12. The computer program product of claim 11, in which the program code further comprises program code to communicate during a TDM on duration with increased resources to compensate for data that would have been transmitted in the TDM off duration if TDM mode was not configured.

13. The computer program product of claim 12 in which the resources comprise at least one of time slots and channel codes.

14. The computer program product of claim 11 in which the TDM off duration comprises consecutive subframes.

15. The computer program product of claim 11 in which the network is a Time Division-Synchronous Code Division Multiple Access (TD-SCDMA) network.

16. An apparatus for wireless communication, comprising:
a memory; and
at least one processor coupled to the memory, the at least one processor being configured:
to report to a base station when a user equipment (UE) moves out of a network coverage area;
to receive an instruction to switch from non-time division multiplexing mode into time division multiplexing (TDM) mode; and
to perform inter-radio access technology (IRAT) measurement in a TDM off duration once the UE is in TDM mode.

17. The apparatus of claim 16, in which the at least one processor is further configured to communicate during a TDM on duration with increased resources to compensate for data that would have been transmitted in the TDM off duration if TDM mode was not configured.

18. The apparatus of claim 17 in which the resources comprise at least one of time slots and channel codes.

19. The apparatus of claim 16 in which the TDM off duration comprises consecutive subframes.

20. The apparatus of claim 16 in which the network is a Time Division-Synchronous Code Division Multiple Access (TD-SCDMA) network.
